(19) United States
(12) Patent Application Publication
(10) Pub. No.: US 2009/0115298 A1
(43) Pub. Date: May 7, 2009

(54) Entertainment cabinet with bi-fold storage doors

(75) Inventors: Timothy J. Parsons, Bryan, OH (US); Douglas P. Krieger, Archbold, OH (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(73) Assignee: Sauder Woodworking Company, Archbold, OH (US)

(21) Appl. No.: 12/075,149

(22) Filed: Mar. 10, 2008

Related U.S. Application Data
(60) Provisional application No. 60/893,933, filed on Mar. 9, 2007.

(51) Int. Cl. E06B 3/70

(52) U.S. Cl. 312/326

(57) ABSTRACT

An entertainment cabinet (100) includes a pair of bi-fold doors (122). The cabinet (100) includes a top (102), sides (104, 106), rear (108) and bottom (110), with a central display space (112) positioned therein. Each of the bi-fold doors (122) includes a first storage door panel (130) having an open-sided channel (141) formed through a first let (136), second leg (138) and bight portion (140). The first leg (136) has an end section (144) hinged with a front section (142) of a left side (106) of the cabinet (100). The first door panel (130) hinges between a closed position, which partially conceals the central display space (112), and an open position, revealing the central display space (112). A second or cover door panel (134) is formed as an L-shaped channel member with a first or short leg (150) and a second or long leg (152). The short leg (150) is connected to the second leg (138) of the storage door panel (130) through a door panel hinges (156). The second door panel (134) hinges between an open position which reveals the door panel storage facilities (132), and a closed position, which conceals the door panel storage facilities (132).

### CROSS-REFERENCE TO RELATED APPLICATIONS

This application claims priority of U.S. Provisional Patent Application Ser. No. 60/893,933 filed Mar. 9, 2007.

### STATEMENT REGARDING FEDERALLY SPONSORED RESEARCH OR DEVELOPMENT

Not applicable.

### PARTIES TO A JOINT RESEARCH AGREEMENT

Not applicable.

### REFERENCE TO A SEQUENCE LISTING

Not applicable.

### BACKGROUND OF THE INVENTION

The invention relates to furniture cabinets that are directed to housing that may commonly be referred to as multimedia or entertainment equipment, including signal processing and presentation devices. More specifically, an entertainment cabinet with bi-fold storage door of the invention is directed to alternating concealment and revealing of multimedia devices and the like, with a bi-fold door that has at least one storage panel. Thus, the door presents a visual impression of a conventional multi-panel storage door, whether bi-fold or not, in a closed position in which the door covers at least a portion of a display space of the entertainment cabinet. Alternatively, in an open position, the bi-fold door may be either folded and present a visual impression of a storage cabinet portion adjacent the display space, or be unfolded and reveal storage provided in the door itself.

Multimedia devices or entertainment equipment that may commonly be housed in an entertainment cabinet may, more specifically, include audio and video tuners and amplifiers and speakers. Such components of multimedia presentation may commonly be visually distracting or otherwise inconsistent with a room environment in which they may be located. Thus, one's attention may be inappropriately drawn to the multimedia equipment, merely by its presence, even when it is not active. Such components of technology support may also present an undesired contrast in the aesthetics of a room environment in which they are located, clashing with the room décor.

While various audio and video components, or multimedia equipment, must be readily accessible and seen in use, it is not always a desired visual element in many room environments when not in use. Thus, one may appreciate a desire to conveniently access and conversely conceal multimedia equipment in a manner in which the equipment does not impose upon its environment when not in use.

Further, conventional media or entertainment cabinets commonly do not provide selective concealment and convenient revealing of storage for smaller accessory items, including recorded media and equipment controllers. The recorded media may be of any of various media, including tapes of various audio and video formats as well as the now more common digital disks, also of various audio and video formats, for example. Thus, one may further appreciate a desire to conveniently access and conversely conceal an inherent visual clutter of the smaller accessory items that invariably accumulate around multimedia display equipment.

### BRIEF SUMMARY OF THE INVENTION

Accordingly, an entertainment cabinet with at least one first bi-fold storage door presents an aesthetically pleasing cabinet that conveniently can present multi-media display equipment, with attention to storage and use of associated, smaller accessory items. The entertainment cabinet includes a bottom, top portion and at least one first side. A central display space is defined between the bottom and the top portion, and adjacent to the first side. The display space is adapted to house various types of devices, including audiovisual equipment and the like. Additional storage and presentation provisions for various audio and video equipment may also be included with the entertainment cabinet.

The first side has a front section, and the first bi-fold door is hinged with the front section of the first side. In accordance with one aspect of the invention, the first bi-fold door has a first door panel connected with the first side of the cabinet. The first door panel or storage door panel may be configured as an open-sided channel member having a first leg, second leg and a bight portion therebetween. The first or storage door panel also has a length between the bottom and the top portion of the entertainment cabinet. More specifically, the storage door panel may preferably be configured with the first leg having an end section hinged through a side hinge with the front section of the first side, with the first leg extending therefrom to the bight portion. The bight portion may preferably extend from the first leg to the second leg of the first door panel. The second leg may preferably extend from the bight portion to a second leg door edge. The first door panel is hinged relative to the first side of the cabinet, and is movable between a closed position in which the first door panel overlays and conceals at least a portion of the display space, and an open position in which the display space is revealed.

In accordance with another aspect of the invention, the bi-fold door includes a second or cover door panel hingedly connected with the first door panel. The second door panel is preferably configured so as to selectively conceal and reveal the door panel storage facilities, when the first door panel is in an open position. The second or cover door panel may be configured as an L-shaped channel member having a first or short leg and a second or long leg. The cover door panel also has a length between the bottom and the top portion of the cabinet. The cover door panel may be configured with the short leg having an end section hinged with a door edge of the second leg of the storage door panel, and extending therefrom to the long leg. The long leg may preferably extend from the short leg to a long leg door edge. The cover door panel may therefore be hinged relative to the storage door panel, and move between a folded position in which the cover door panel overlays and conceals at least a portion of the door panel storage facilities, and an unfolded or open position in which the door panel storage facilities are revealed.

These and other features, objects, and benefits of the invention will be recognized by one having ordinary skill in the art and by those who practice the invention, from this disclosure, including the specification, the claims, and the drawing figures.

### BRIEF DESCRIPTION OF THE SEVERAL VIEWS OF THE DRAWING

FIG. 1 is a top front right perspective view of an exemplary embodiment of an entertainment cabinet with bi-fold storage door of the invention;

FIG. 2 is a front perspective thereof, showing the bi-fold doors in an open position, revealing all of the interior thereof, the door cover panels being shown between their folded and unfolded positions;

FIG. 3 is the view of FIG. 2, showing the cover of the bi-fold door folded, concealing the bi-fold door storage;

FIG. 4 is a front elevation thereof;

FIG. 5 is a right side elevation thereof;

FIG. 6 is a centerline cross section thereof;

FIG. 7 is a top plan view thereof;

FIG. 8 is a fragmentary top plan view thereof with the cabinet top removed, showing the bi-fold storage door thereof in a closed position with the cover panel unfolded;

FIG. 9 is the view of FIG. 8, showing the bi-fold storage door partially open;

FIG. 10 is the view of FIG. 9, showing the bi-fold storage door in an alternative partially open position with the cover panel partially folded;

FIG. 11 is the view of FIG. 9, showing the bi-fold storage door in a fully extended open position with the cover panel unfolded;

FIG. 12 is the view of FIG. 11, showing the cover panel partially folded; and

FIG. 13 is the view of FIG. 11, showing the cover panel folded, concealing the first panel storage.

### DETAILED DESCRIPTION OF THE INVENTION

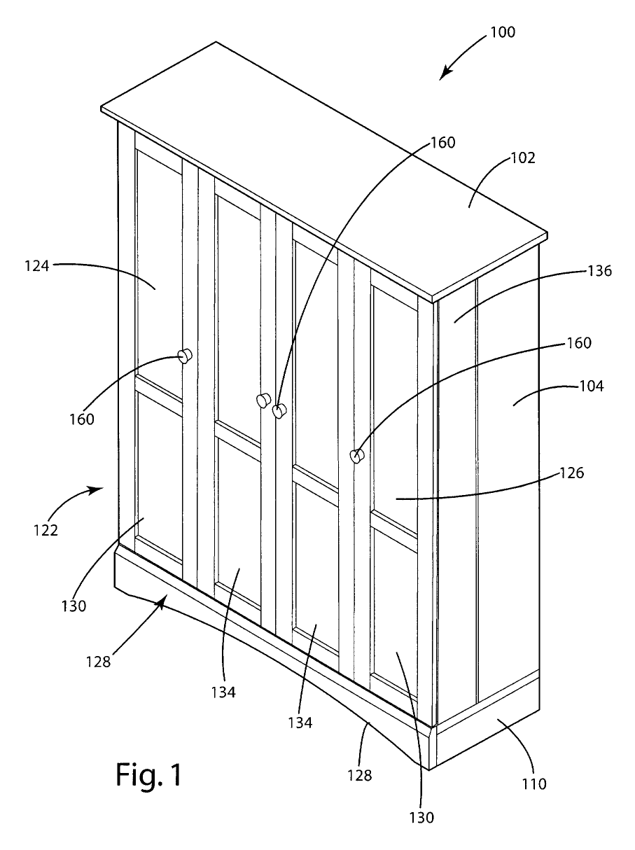

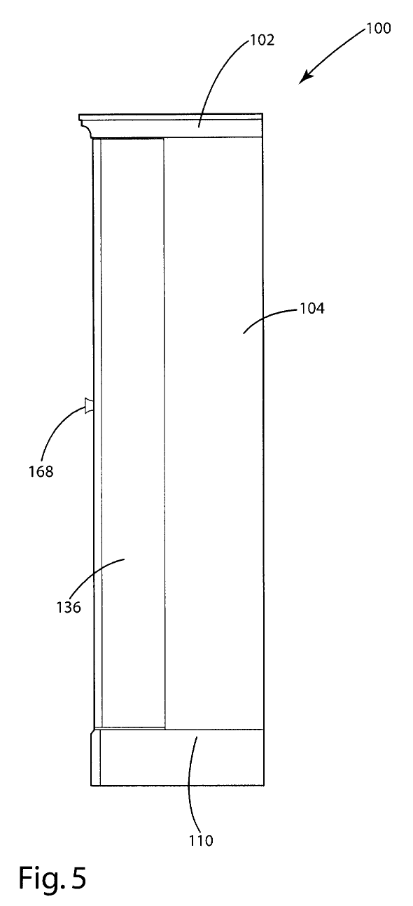

The principles of the invention are disclosed, by way of example, with respect to an entertainment cabinet 100 as described in subsequent paragraphs herein and illustrated in FIGS. 1-13. The entertainment cabinet 100 in accordance with the invention comprises a pair of bi-fold storage doors which present an aesthetically pleasing cabinet which conveniently presents multimedia display equipment, with attention to storage and use of associated, smaller accessory items. Further in accordance with the invention, each of the bi-fold doors includes a pair of door panels, including a first storage door panel and a second cover door panel. As will be made apparent from subsequent descriptions herein, the second door panels can be utilized to selectively cover or otherwise conceal storage areas of the corresponding first storage door panels when the bi-fold doors are in open configurations.

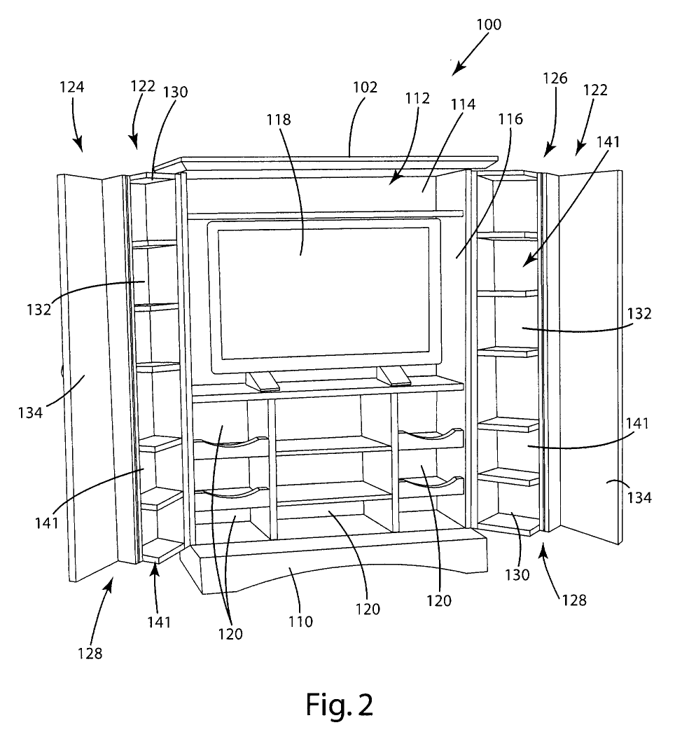

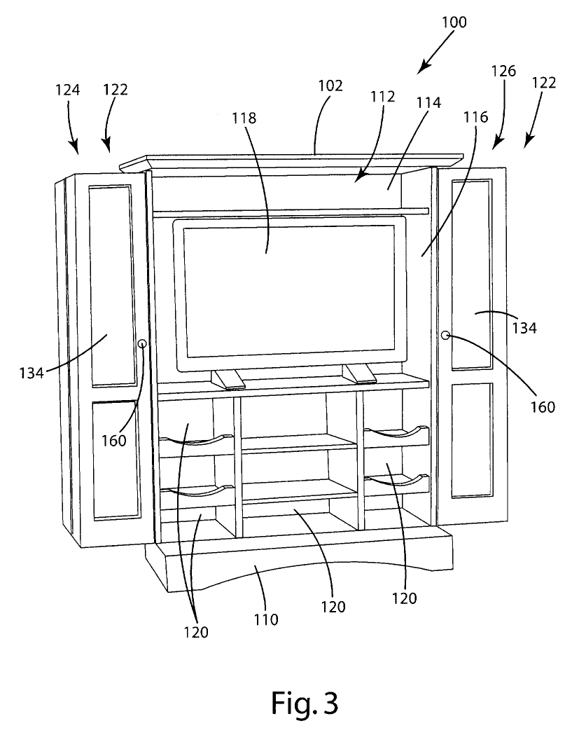

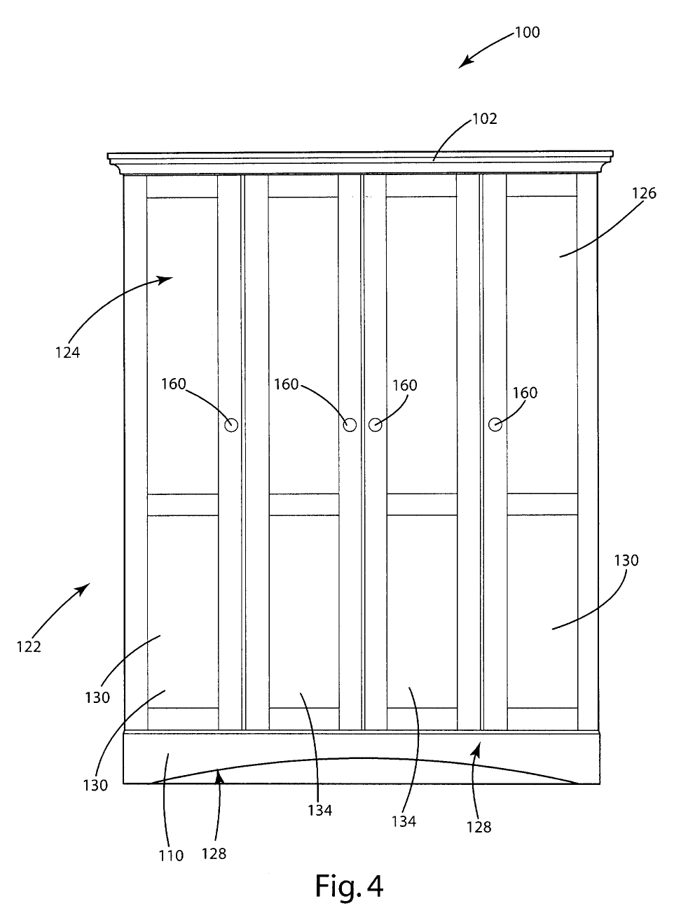

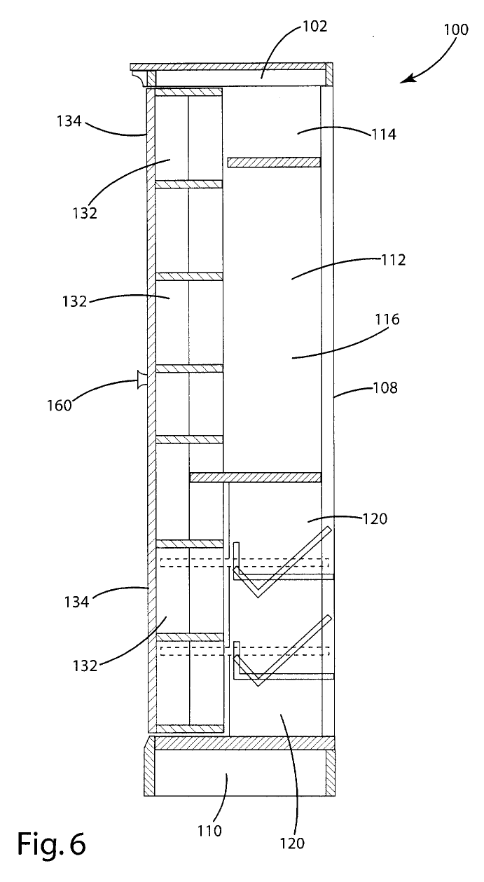

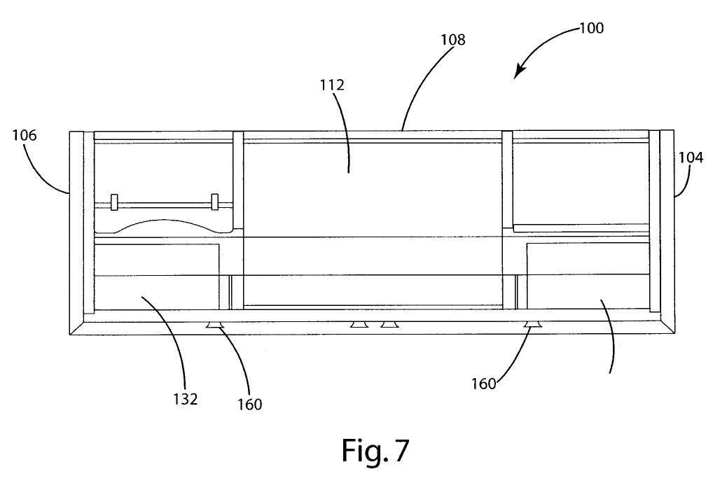

Turning to the drawings, the entertainment cabinet 100 having bi-fold doors in accordance with the invention is disclosed in several views of the drawing, including FIGS. 1-8. As shown therein, the entertainment cabinet 100, which can be any of a number of different sizes and types of cabinets, may include a top 102 covering internal areas of the cabinet 100. The cabinet 100 may also include a right side 104 (with the terms “left” and “right” being merely terms for orientation and convenience, and not representing any particular aspects of the invention). The terms “right” and “left” will be utilized with respect to the view looking into the page on which FIG. 4 illustrates the entertainment cabinet 100. In addition to the right side 104, the entertainment cabinet 100 also includes a left side 106 (shown in side view in FIG. 6), and a rear section 108 (shown in FIG. 7). The cabinet 100 may also include a bottom section 110. An interior area of the entertainment cabinet 100 is illustrated, for example, in FIGS. 2 and 3, and includes a central display space 112. The central display space 112 can include any numbers of different types and sizes of display areas, shelving and the like. In the example embodiment for the entertainment cabinet 100, the central display space 112 can include a center upper shelf 114, primarily shown in FIGS. 2 and 3. Positioned below the center upper shelf 114 is a monitor display area 116. The monitor display area 116 may include any type of shelving facilities (including shelving which may be selectively extendable and retractable) for purposes of holding equipment such as a monitor 118 shown as an example in FIGS. 2 and 3. Positioned below the monitor display area 116 can be a series of shelf systems 120 which may be utilized, for example, to support and house various types of audio and video equipment. Again, the shelf system 120 is primarily shown in FIGS. 2 and 3.

In accordance with certain principal aspects of the invention, the entertainment cabinet 100 includes a pair of bi-fold doors 122 as shown in a number of the drawings, including FIGS. 2, 3 and 4. The pair of bi-fold doors 122 includes a first bi-fold door 124 shown in the drawings as being on the left front portion of the entertainment cabinet 100, and a second bi-fold door 126 positioned on the right front portion of the entertainment cabinet 100. Each of the first and second bi-fold doors 124, 126, respectively, includes a pair of door panels 128. Preferably, though not required in accordance with the invention, the door panels 128 may extend from adjacent the top 102 of the entertainment cabinet 100 to an area adjacent the bottom 110 of the entertainment cabinet 100. Each of the pair of door panels 128 includes a first door panel 130, which can be characterized also as a storage door panel 130. As shown particularly in FIG. 2, each of the storage door panels 130 includes an interior area which can be characterized as a door panel storage facilities area 132. The door panel storage facilities area 132 for each of the storage door panels 130 may include various types of shelving and spacial areas for purposes of holding books, DVDs, audiovisual equipment, or any of a number of other types of items which may be useful for a user to have located within the entertainment cabinet 100 in a manner so as to be accessible to the user. It should be emphasized that the particular configuration of the door panel storage facilities area 132 does not have to be the same for each of the storage door panels 130. That is, various configurations can be utilized for each of the storage door panels 130.

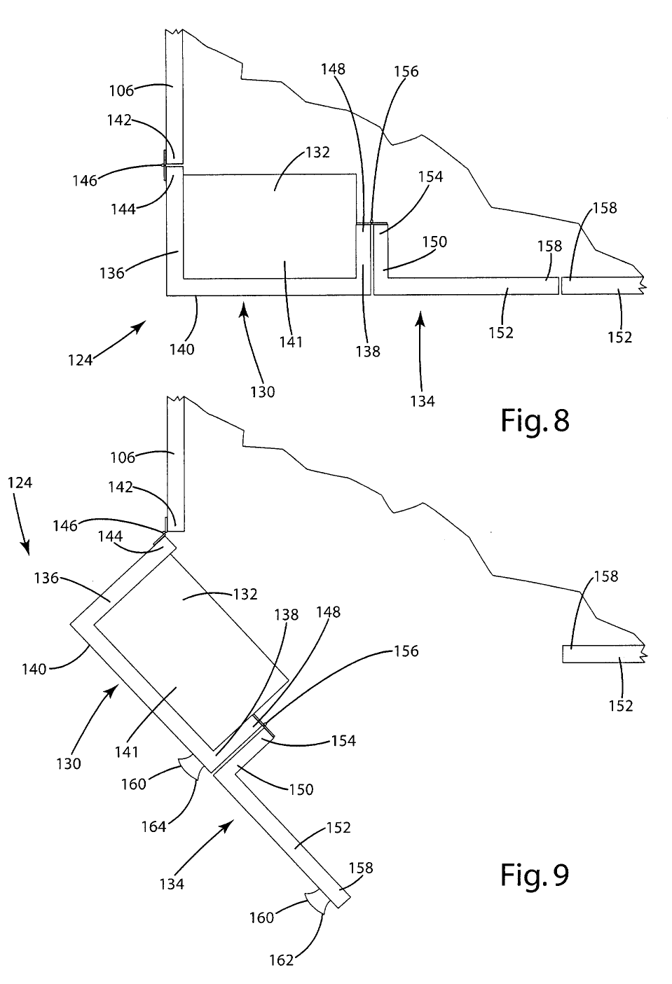

In addition to the storage door panels 130, each of the pair of bi-fold doors 122 also includes a second door panel 134. The second door panel 134 can be characterized as a cover door panel 132, as will be apparent from subsequent description herein. As illustrated particularly in FIGS. 8-13, each of the storage door panels 130 can include a first leg 136, second leg 138, and bight portion 140 extending therebetween. Preferably, the bight portion 140 is integral with the first and second legs 136, 138, respectively. An open-sided channel 141 is formed by the legs 136, 138 and the bight portion 140. The storage facilities area 132 can be located in the open-sided channel 141.

For purposes of description, the first bi-fold door 124 which is hingedly or pivotably connected to the left side 106 of the entertainment cabinet 100 will now be described in detail, both with respect to configuration and operation. From this description, the configuration and operation of the second bi-fold door 126, which is pivotably or hingedly connected to the right side 104 of the entertainment cabinet 100, will be made apparent.

For purposes of description, the left side 106 of the cabinet 100 can be characterized as having a front section 142, as primarily shown in FIGS. 8-13. Correspondingly, the first leg 136 of the storage door panel 130 can be characterized as having an end section 144 which is positioned adjacent the front section 142 of the leg 106. The front section 142 of the left side 106 and the end section 144 of the first leg 136 are pivotably or hingedly connected together through the use of one or more conventional side hinges 146. As shown, for example, in FIG. 9, when the storage door panel 130 and the left side 106 are pivoted relative to each other about the side hinges 146, the left side 106 of the entertainment cabinet essentially remains stationary, while the storage door panel 130 moves hingedly or pivotably relative thereto.

With this configuration, the first leg 136 extends from the side hinge 146 to the bight portion 140. Correspondingly, the bight portion 140 extends from the first let 136 to the second leg 138. Preferably, the bight portion 140 has an outer surface which defines a finished door panel for the cabinet 100. The second leg extends perpendicular to the bight portion 140 and terminates at a second leg door edge 148. Accordingly, the storage door panel 130 can be characterized as an open-sided channel which defines the door panel storage facilities areas 132, as bounded by the bight portion 140, first leg 136, and second leg 138. This storage door panel 130 can further be characterized as hinged relative to the left side 106 between a closed position, in which the storage door panel overlays and conceals at least a portion of the central display space 112, and an open position, in which the central display space 112 is not concealed by the storage door panel 130. The closed position is illustrated in FIG. 8, while the fully open position is illustrated in FIG. 13.

Reference will now be made to the cover door panel 134, and its structural and connective relationship to the storage panel 130. Again, primarily with respect to FIGS. 8-13, the cover panel 134 includes what can be characterized as an L-channel or L-shaped member with a first leg 150 and a second leg 152 extending perpendicular from the first leg 150. With the particular configuration of an entertainment cabinet 100 in accordance with the invention as shown herein, the first leg 150 can be characterized as a short leg 150, while the second leg 152 can be characterized as a long leg 152. As further shown in the drawings, the first leg 150 can be characterized as having an end section 154 which terminates adjacent the termination of the door edge 148 of the second leg 138 of the storage panel 130. The door edge 148 and the end section 154 are pivotably coupled together through the use of one or more conventional door panel hinges 156. As with the previously described hinges 146, the door panel hinges 156 and the cover panel 134 preferably extend vertically and lengthwise between the top 102 and the bottom 110 of the entertainment cabinet 100. The second leg or long leg 152, as further shown in the drawings, extends from the first leg or short leg 150 to a terminating door edge 158. Preferably, the door edge 158 terminates adjacent a door edge 158 of the second bi-fold door 126. If desired, various types of releasable connecting mechanisms may be utilized to couple together the adjacent long legs 152 of the pair of bi-fold doors 122.

The operations of the pair of bi-fold doors 122 will now be described, primarily with respect to FIGS. 8-13. Only the functional operation of the first bi-fold door 124 will be described, since the operation of the second bi-fold door 126 is substantially identical, with the operation occurring substantially as a “mirror image” of the structural and functional operation of the first bi-fold door 124.

The first bi-fold door 124 will first be assumed to be in a fully “closed” position, relative to the central display space 112 of the entertainment cabinet 100. This central storage display space 112 is concealed in view of the positions of the bight portion 140 of the storage door panel 130 and the second or long leg 152 of the cover panel 134 essentially covering the central storage display space 112.

To open the first bi-fold door 124, knobs 160 (shown in FIGS. 1 and 3) or similar types of handles may be secured at appropriate positions on the storage door panel 130 and the cover door panel 134 for purposes of facilitating a user opening the bi-fold door 124. An example of the knobs 160 is also shown in FIG. 9. For purposes or clarity, the knobs 160 have not been shown in FIG. 8 or FIGS. 10-13. Still further, for purposes of description, the knobs 160 shown in FIG. 9 have further been specified as including a cover panel knob 162 and a storage panel knob 164.

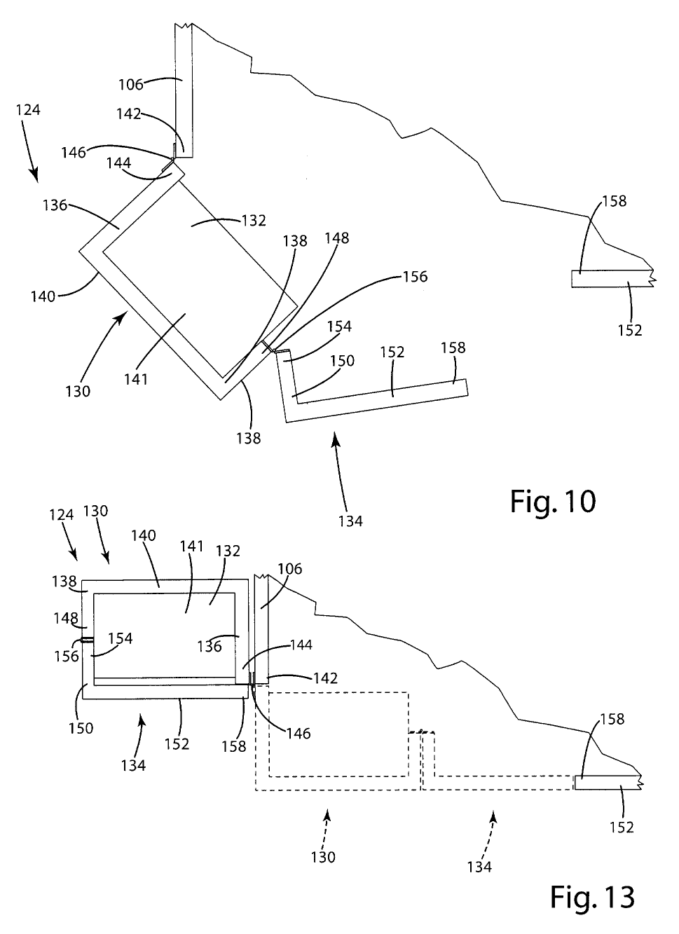

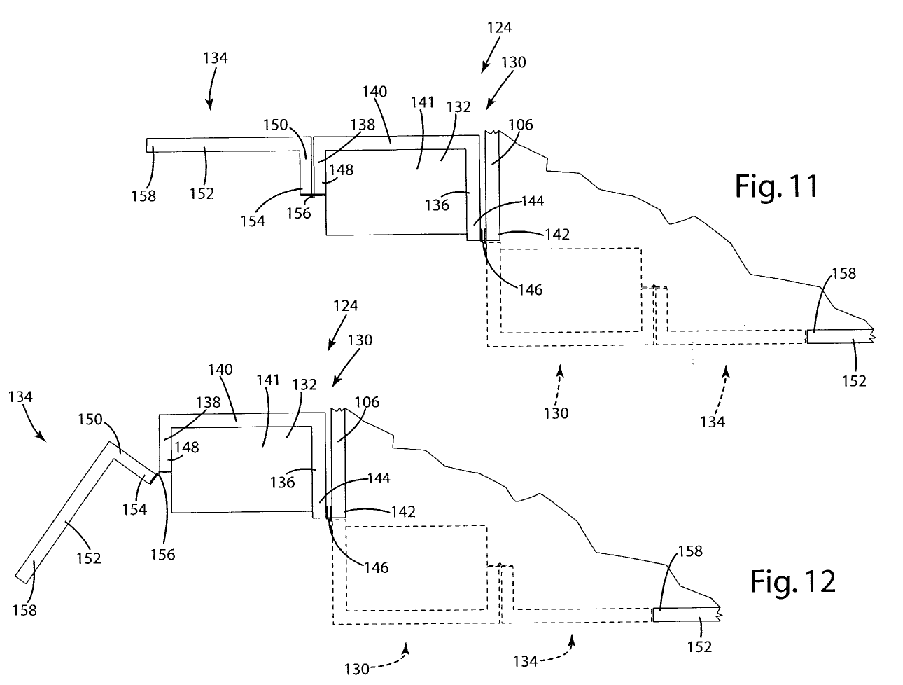

For the user to initially open the first bi-fold door 124 from its closed position as shown in FIG. 8, the user may first grasp the cover panel knob 162 and exert outwardly directed forces thereon. The forces required for initially opening the bi-fold door 124 can be varied in numerous ways, including varying the “frictional tension” of the side hinges 146. These forces exerted on the cover door panel 134 through the cover panel knob 162 will cause the first bi-fold door 124 to swing outwardly, as shown in FIG. 9. Correspondingly, when the first bi-fold door 124 is in the position shown, for example, in FIG. 9, a user may, if desired, exert outwardly directed forces on the storage panel knob 164. Dependent upon the “frictional tension” of the door panel hinges 156, such forces exerted on the storage panel knob 164 and the storage panel 130 may cause the cover door panel 134 and the storage door panel 130 to pivot relative to each other. Such a configuration is illustrated in FIG. 10. When the first bi-fold door 124 is in the position illustrated in FIG. 9 or FIG. 10, the user can further exert appropriate forces on the bi-fold door 124 so as to cause further hinged rotation of the storage door panel 130 relative to the left side 106 through the hinges 146. Such pivotable movement may continue until the first bi-fold door 124 is in the position illustrated in FIG. 12. In this position, the first leg 136 of the storage door panel 130 has been hingedly rotated through the side hinge 146 relative to the left side 106 so that the first leg 136 is adjacent and parallel to the left side 106. In this position, the door panel storage facilities 132 are completely revealed and open to the user, as is the central storage area space 112. It should be noted that in FIGS. 11, 12 and 13, the initial, closed position of the first bi-fold door 124 is shown, for comparison purposes, in “phantom line” format.

With the door panel storage facilities 132 completely revealed as illustrated in FIG. 11, it is also shown that the cover door panel 134 is in a fully “open” configuration, with the first or short leg 150 positioned adjacent and parallel to the second leg 138 of the storage door panel 130. This relative movement has occurred through the door panel hinges 156. The user may now wish to continue to maintain the central storage area 112 in a completely “revealed” or “open” configuration, while correspondingly concealing the door panel storage facilities 132 of the first bi-fold door 124. If this is desired, forces can be exerted by the user on the cover door panel 134 so as to cause the cover door panel 134 to pivotably rotate about the door panel hinge 156 relative to the storage door panel 130, in the direction shown from FIG. 11 to FIG. 12.

Further exertion of forces on the cover panel 134 relative to the storage door panel 130 will cause a continuing pivot of the cover door panel 134 about the door panel hinge 156, so that the cover door panel 134 moves from the position illustrated in FIG. 12 to the position illustrated in FIG. 13. In this position, the second or long leg 152 of the cover door panel 134 is essentially parallel to the bight portion 140 of the storage door panel 130. This position may be characterized as the “closed” or “concealed” position. That is, with the cover door panel 134 in the position illustrated in FIG. 13, the door panel storage facilities 132 are completely concealed or hidden from view. Correspondingly, however, the central display space 112 is completely open and revealed to the user. In accordance with all of the foregoing, and in accordance with various aspects of the invention, each of the pair of bi-fold doors 122 provides for the capability of fully concealing or fully revealing the central display space 112 of the cabinet 100. Further, the bi-fold doors 122 in accordance with certain aspects of the invention provide for the capability of door panel storage facilities separate and apart from the central display space 112. Also, the bi-fold doors 122 in accordance with other aspects of the invention provide for the capability of revealing the door panel storage facilities 132 at the same time as revealing the central storage area 112. Alternatively, with the bi-fold doors 122 in accordance with other aspects of the invention, the central display space 112 can be revealed, while the door panel storage facilities 132 can be concealed.

One having ordinary skill in the art and those who practice the invention will understand from this disclosure that various modifications and improvements may be made without departing from the spirit of the disclosed inventive concept. One will also understand that various relational terms, including left, right, front, back, top, and bottom, for example, may be used in this detailed description of the invention and in the claims only to convey relative positioning of various elements of the claimed invention without limitation to the invention.

What is claimed is:

1. An entertainment cabinet having at least one bi-fold storage door, said entertainment cabinet comprising:
a display cabinet having a top area, bottom and at least one first side, with said first side having a front section extending toward the front of said entertainment cabinet;
a central display space defined between said bottom and said top portion;
a first door panel coupled to said first side, said first door panel forming an open-sided channel having a first leg, second leg and bight portion extending between said first and second legs, and extending lengthwise between said top portion and said bottom of said entertainment cabinet;
said first leg of said first door panel having an end section hinged with said front section of said first side and extending therefrom to said bight portion;
said bight portion extending from said first leg to said second leg, and said second leg extending from said bight portion to a second leg door edge;
said first door panel hinges relative to said first side between a closed position, in which said first door panel overlays and conceals at least a portion of said central display space, and an open position, in which said central display space is not concealed by said first door panel;
a second door panel connected to said first door panel, said second door panel being an L-shaped channel member having a first or short leg and a second or long leg, and extending lengthwise between said top portion and said bottom of said entertainment cabinet;
said short leg having an end section hinged with said second leg door edge and extending therefrom to said long leg, said long leg extending from said short leg to a door edge of said long leg; and
said second door panel hinges relative to said first door panel between an open position in which said second door panel reveals at least a portion of said first door panel channel open-sided channel, and a closed position, in which said first door panel channel open-sided channel is concealed by said second door panel.
